(19) United States
(12) Patent Application Publication
(10) Pub. No.: US 2025/0123361 A1
(43) Pub. Date: Apr. 17, 2025

(54) METHOD AND CONTROL DEVICE FOR DETECTING ERRONEOUS ANTENNA SIGNALS FROM A RADAR SENSOR HAVING A PLURALITY OF ANTENNAS

(71) Applicant: Robert Bosch GmbH, Stuttgart (DE)

(72) Inventors: Benedikt Loesch, Stuttgart (DE); Arthur Hipke, Leonberg (DE)

(21) Appl. No.: 18/695,205

(22) PCT Filed: Nov. 14, 2022
(86) PCT No.: PCT/EP2022/081819

§ 371 Date: Mar. 25, 2024

(30) Foreign Application Priority Data
Dec. 17, 2021 (DE) 10 2021 214 639.2

(51) Int. Cl. G01S 7/40; G01S 13/02; G01S 13/42

(52) U.S. Cl. CPC G01S 7/4091; G01S 7/4021; G01S 13/42; G01S 2013/0245

(57) ABSTRACT

A method for detecting erroneous antenna signals from a radar sensor having a plurality of antennas. A subset of the antenna signals is formed by omitting at least one antenna signal from a complete set of the antenna signals. A direction to an object is estimated using the subset and an antenna pattern of the radar sensor and, in so doing, a correlation value of the subset of the antenna signals with the antenna pattern in the estimated direction is determined. The at least one omitted antenna signal for the subset is classified as erroneous if the correlation value satisfies a selection condition.

### FIELD

The present invention relates to a method for detecting erroneous antenna signals from a radar sensor having a plurality of antennas, a corresponding control device, and a corresponding computer program product.

### BACKGROUND INFORMATION

A radar sensor can have a plurality of antennas and a reference direction. The antennas may, for example, be oriented transversely, in particular orthogonally, to the reference direction. The reference direction may be a surface normal of a planar radar sensor. However, the antennas may also have an offset, e.g., on a curved surface. When a radar signal hits the radar sensor from a different direction than the reference direction, wavefronts of the radar signal hit the antennas at different times. Strictly speaking, this applies to all directions, for example due to heterogeneities in the radome. The different times cause a phase offset in antenna signals of the antennas. The direction can be determined from the phase offset.

An antenna pattern of the radar sensor can be used to determine the direction. The antenna pattern is a measurement of the phase offsets and the associated channel amplitudes. The antenna pattern can represent expected phase offsets and channel amplitudes for radar signals arriving from different directions. The antenna pattern can, for example, be created by measuring the radar sensor by means of a reference antenna, a retroreflector, or a target generator.

If the radar sensor is, for example, installed behind a diaphragm, such as a bumper or emblem, the diaphragm can interfere with the reception of the radar signals and the antenna signals can be erroneous. In particular, the antenna signals can have a phase shift due to the diaphragm. The phase shift can distort the phase offset resulting from the direction. Due to the erroneous antenna signals, the direction can be read incorrectly from the antenna pattern.

### SUMMARY

With the approach presented here according to the present invention, a method for detecting erroneous antenna signals from a radar sensor having a plurality of antennas, a corresponding control device, and a corresponding computer program product are provided. Advantageous developments and improvements of the approach presented here emerge from the description and the rest of the disclosure herein.

For monitoring the environment in driver assistance systems, in addition to the distance and the relative velocity, the azimuth angle and the elevation angle are also of great importance since they can be used to carry out a lane assignment and make a statement on the relevance of the target (can be driven over, can be driven around on the oncoming lane, can be driven under). Azimuth and elevation angles of the targets can be ascertained from amplitude and/or phase differences of transmitting and/or receiving antennas of an antenna array.

In the angle estimation, the receive signals for one or more transmitting antennas are compared to a previously measured angle-dependent antenna pattern. Generally, the antenna pattern is not measured across all azimuth and elevation angle combinations but only by means of two sections (e.g., azimuth section at elevation=0° and elevation section at) azimuth=0°. Alternatively, the antenna pattern can also be generated from an ideal antenna pattern by means of one or a few calibration measurements at individual angular positions.

In the event that only one target is in a (d,v) cell, the estimated angle results as the position of the best match (correlation) between the receive signal and the antenna pattern.

Aging effects, temperature effects, and concealed installation of the sensor behind an emblem or bumper can result in a deviation between the measured antenna pattern and the amplitude and phase differences occurring in practice between the transmitting and/or receiving antennas. In principle, such deviations can also occur due to a misalignment of the sensor (e.g., elevation misalignment: The plurality of targets has elevation angles that deviate significantly from the azimuth calibration section) or due to an imperfect calibration (low number of calibration measurements). These deviations can result in angle errors and in degradation of the correlation value.

The three effects (aging, temperature, concealed installation) are assumed to be static (within a temperature range) or only slowly variable.

According to an example embodiment of the present invention, the correlation value is inter alia used to detect superpositions of multiple targets within a (d,v) cell and to activate multi-target angle estimation algorithms. Likewise, the correlation value can be used to detect distortive blindness, i.e., an impairment of the angle measurement capability due to a coating (e.g., ice, snow, slush) on the sensor. Furthermore, the correlation value can be used as a quality criterion for the reliability of the estimated value and as an important criterion in object formation (tracking).

A degradation of the correlation value due to the effects described above can thus lead to mistakenly increased activation of the multi-target angle estimation algorithms (ghost targets with large angle errors of several degrees) on the one hand and to mistakenly increased detection of distortive blindness on the other hand. A degradation of the correlation value may also impair object formation.

Until now, it has only been possible to compensate for the degradation of the correlation value but not for any existing angle error. In order to calibrate a MIMO radar sensor, a change in the zero point of the radar sensor can be monitored and, if a deviation is too large, the angular deviation can be compensated by applying a compensation factor to the calibration coefficients. Thus, only a global angular offset can be calibrated. It has not been possible, until now, to take local or angle-dependent angle errors into account in the calibration.

By the approach presented here according to the present invention, in addition to compensating for the degradation of the correlation value, compensation for the global and local angle errors can be made possible directly in the determination of the calibration coefficients, provided that the amplitude and phase errors for a subset of transmitting and receiving antennas are less pronounced than for the remaining antennas.

Phase and/or amplitude information of antenna signals of different antennas of a radar sensor are characteristic of a direction to an object. An antenna pattern of the radar sensor stores phase and/or amplitude information for different directions. According to an example embodiment of the present invention, in order to determine the direction, the phase and/or amplitude information of the antenna signals are searched in the antenna pattern analogously to a pattern search. Where the phase and/or amplitude information of the antenna signals best matches the antenna pattern, i.e., the correlation between the antenna signals and the antenna pattern is the greatest, the direction is detected. The correlation can achieve a maximum value if the phase and/or amplitude information exactly matches the antenna pattern. The lower the correlation value, the less the antenna pattern matches the antenna signals. The correlation calculation can be standardized as desired, for example to the value range [0,1].

If the antenna signals are erroneous, they have altered phase and/or amplitude information. The altered phase and amplitude information no longer fully matches but is similar to the antenna pattern. The correlation between the antenna signals and the antenna pattern is reduced by the error and the pattern search becomes systematically erroneous.

The fact that not all antenna signals are equally erroneous is exploited here. If the highly erroneous antenna signals are not used to estimate the direction, an improved correlation and an improved estimation can be achieved.

In the approach presented here according to the present invention, the erroneous antenna signals are detected by using a selection of the antenna signals to estimate the direction and by comparing the resulting correlation to at least one predefined criterion. If the correlation corresponds to the criterion, the antenna signals not used for the selection are detected as the erroneous antenna signals. Since antenna signals are always erroneous, for example as a result of thermal noise, the approach presented here makes it possible to detect channels that have greater errors than is the case in the other channels.

The estimation can be performed iteratively by repeating steps, respectively omitting different antenna signals, and checking the resulting correlations on the basis of the criterion. The selection whose correlation satisfies the criterion indicates the erroneous antenna signals via the non-selection thereof.

According to an aspect of the present invention, a method for detecting erroneous antenna signals from a radar sensor having a plurality of antennas is proposed, wherein a subset of the antenna signals is formed by omitting at least one antenna signal from a complete set of the antenna signals, wherein a direction to an object is estimated using the subset and an antenna pattern of the radar sensor, and a correlation value of the subset of the antenna signals with the antenna pattern in the estimated direction is determined, wherein the at least one omitted antenna signal for the subset is classified as erroneous if the correlation value satisfies a selection condition.

Ideas for embodiments of the present invention may, inter alia, be regarded as being based on the concepts and findings described below.

An antenna signal may be an electrical signal. The antenna signal may represent electromagnetic waves received from an associated antenna, or properties characterizing such electromagnetic waves, such as phase and/or amplitude information. In a radar sensor, the antenna signal may represent an echo of an emitted radar signal.

According to an example embodiment of the present invention, the radar sensor can have a plurality of antennas, in particular more than two, more than three, or more than four antennas. The antennas may be transmitting antennas and/or receiving antennas. The antennas can be arranged spatially spaced apart from one another. All antennas may represent the same echo in a respective antenna signal. All antenna signals together form a complete set of the antenna signals.

According to an example embodiment of the present invention, the antennas can be arranged in a defined arrangement relative to one another. For example, the antennas may be arranged at distances that correspond to fractions and/or multiples of a wavelength of the radar signal. As a result of the arrangement, the echo may reach the antennas at different times. The different times can be represented as phase offset in the antenna signals. The antenna signals can thus have different phase positions. The phase offsets or phase positions of the antenna signals vary depending on the direction from which the echo is received. The antenna signals may also have different amplitudes depending on the direction.

According to an example embodiment of the present invention, a subset may be a selection of the antenna signals. The subset may comprise at least one antenna signal less than the complete set does.

An antenna pattern can represent phase and/or amplitude information of the antenna signals from the radar sensor as a function of the direction. The antenna pattern may, for example, be created by measuring the radar sensor using a reference transmitter that is movable relative to the radar sensor and in particular has a constant transmit power. The antenna pattern may also originate from analytical calculations. The antenna pattern may represent the phase offset of the antenna signals over the direction. The antenna pattern may also represent an amplitude of the antenna signals over the direction. The amplitudes may in this case indicate a directional characteristic of the radar sensor.

According to an example embodiment of the present invention, in order to estimate the direction, the phase and/or amplitude information of the antenna signals from the subset can be compared to the antenna pattern. The at least one omitted antenna signal can be ignored in the comparison.

The direction can be found where the phase and/or amplitude information of the antenna signals best matches the antenna pattern, or where a correlation with the antenna pattern is the greatest. The correlation can be represented in a numerical value. The numerical value may be referred to as a correlation value.

According to an example embodiment of the present invention, a selection condition may be a minimum value for the correlation value. For example, from a correlation value greater than 0.95, the antenna signals of the subset can be classified as substantially free of errors, while the at least one omitted antenna signal is marked as erroneous. The estimated direction to the object for this subset can be output as an angle to the object. The selection condition is generally predetermined.

The selection condition may be dependent on a noise distance of the antenna signals. The noise distance may be referred to as interference distance or signal-to-noise ratio (SNR).

In particular, the antenna signals of the subset can be classified as error-free if the achieved correlation value is one or a full match is found. The classification of the subset as error-free or erroneous may take place taking into account a predetermined tolerance.

As an alternative or in addition, the resulting angles may also be considered; in this case, the erroneous channel results in highly deviating angle estimations for the subsets that include it.

According to an example embodiment of the present invention, a further subset may be formed from the complete set by omitting at least one other antenna signal from the complete set if the correlation does not satisfy the selection condition. This can take place in a further method step within the framework of an iterative embodiment of the method described here. Using the further subset and the antenna pattern, a further direction to the object can be estimated and, in so doing, a further correlation value of the further subset of the antenna signals with the antenna pattern in the estimated further direction can be determined. The at least one other omitted antenna signal for the further subset can be classified as erroneous if the further correlation value satisfies the selection condition. The further estimated direction can be selected as the angle to the object if the further correlation value satisfies the selection condition. If the correlation value does not satisfy the selection condition, the search can continue until the correlation value satisfies the selection condition. Thus, several different subsets can be tested one after the other or in parallel.

The correlation values of the estimations can be compared to one another if no correlation value satisfies the selection condition. The direction of the subset with the greatest correlation value can be selected as the angle to the object. The at least one omitted antenna signal for this estimation can be classified as erroneous. Several antenna signals can be more or less erroneous. If the correlation values of all subsets do not satisfy the selection conditions, the best correlating subset can be selected in order to find the at least one erroneous antenna signal.

According to an example embodiment of the present invention, using all antenna signals and the antenna pattern, a rough direction to the object can be ascertained first. The estimation of the direction using the subset can then be limited to a direction range around the rough direction. A rough direction can indicate a direction range in the antenna pattern. The direction range can indicate a section of the antenna pattern. The more accurate estimation of the direction can take place within the direction range. As a result of an upstream rough estimation, the best matching subset can be found quickly since the correlation of the subset is no longer performed for all angular positions of the antenna pattern.

The subset can comprise at least three antenna signals. The correlation values of several estimations can be compared starting from three or more antenna signals.

According to an example embodiment of the present invention, a rough direction to the object can be read in. The estimation of the direction using the subset can be limited to a direction range around the rough direction. The subset can comprise at least two of the antenna signals. The rough direction can be read from another sensor. If the rough direction is known, the subset whose direction best matches the rough direction can be used. In this case, the correlation may be less relevant.

Using all antenna signals and at least one object criterion, the object can be selected from a group of objects represented in the antenna signals. Using all antenna signals, objects in a detection range of the radar sensor can be searched and found. One of these objects can be selected in order to detect the at least one erroneous antenna signal. The object can specify the rough direction. For a deviating rough direction, at least one erroneous antenna signal can be sought using another object in the deviating rough direction. The search in the other rough direction can take place at another time.

Using the estimated direction, a compensation value for the at least one antenna signal classified as erroneous can be calculated. Using the compensation value, it is possible to compensate for the at least one antenna signal classified as erroneous and, as an alternative or in addition, for the antenna pattern. As a result of the compensation, erroneous antenna signals can also be used since the cause of the contained error can be compensated computationally.

According to an example embodiment of the present invention, an antenna pattern vector assigned to the estimated direction can be compensated with the calculated compensation value. Thus, the angle error resulting from the phase and/or amplitude error of the erroneous channel can be corrected in the current and/or in future measurement cycles.

The at least one erroneous antenna signal can be determined via at least two measurements of the object. Measurements can be taken one after the other over time. In particular, successive measurements can be used. Due to a small time offset between the measurements, the measurements can differ only slightly. The determination of the at least one erroneous antenna signal can be assured by means of several measurements. Through several measurements, random interferences of the antenna signals can be detected.

According to an example embodiment of the present invention, one compensation value can be calculated per measurement. The compensation values of the measurements can be time-filtered in order to obtain a filtered compensation value. The at least one antenna signal classified as erroneous and, as an alternative or in addition, the antenna pattern can be compensated using the filtered compensation value. Filtering can reduce a fluctuation of the filtered compensation value. The filtering can remove outliers in the compensation values. As a result of the filtering, the filtered compensation value can have a smoothed profile.

The method according to the present invention can be implemented, for example, in software or hardware or in a mixed form of software and hardware, for example in a control device.

The approach presented here according to the present invention furthermore provides a controller which is designed to carry out, control, or implement, in corresponding devices, the steps of a variant of the method presented here.

The control device can be an electrical device with at least one computing unit for processing signals or data, at least one memory unit for storing signals or data, and at least one interface and/or one communication interface for reading or outputting data embedded in a communication protocol. The computing unit may, for example, be a signal processor, a so-called system ASIC, or a microcontroller for processing sensor signals and outputting data signals as a function of the sensor signals. The memory unit may be a flash memory, an EEPROM or a magnetic memory unit, for example. The interface can be configured as a sensor interface for reading the sensor signals from a sensor and/or as an actuator interface for outputting the data signals and/or control signals to an actuator. The communication interface can be configured to read in or output the data wirelessly and/or by wire. The interfaces may also be software modules that are present, for example, in a microcontroller in addition to other software modules.

A computer program product or a computer program with program code that can be stored on a machine-readable carrier or storage medium, such as a semiconductor memory, a hard disk memory, or an optical memory, and that is used to carry out, implement, and/or control the steps of the method according to one of the embodiments described above is advantageous as well, in particular if the program product or program is executed on a computer or an apparatus.

It should be noted that some of the possible features and advantages of the present invention are described herein with reference to different embodiments. A person skilled in the art recognizes that the features of the control device and of the method can be suitably combined, adapted, or replaced in order to arrive at further embodiments of the present invention.

### BRIEF DESCRIPTION OF THE DRAWINGS

Embodiments of the present invention are described below with reference to the figures, wherein neither the figures nor the description are to be construed as limiting the present invention.

FIG. 1 shows a representation of a sequence of a method according to an exemplary embodiment of the present invention.

FIG. 2 shows a further representation of a sequence of a method according to an exemplary embodiment of the present invention.

FIG. 3 shows a representation of direction estimations according to an exemplary embodiment of the present invention.

The figures are merely schematic and are not to scale. Identical reference signs denote identical or functionally identical features.

### DETAILED DESCRIPTION OF EXAMPLE EMBODIMENTS

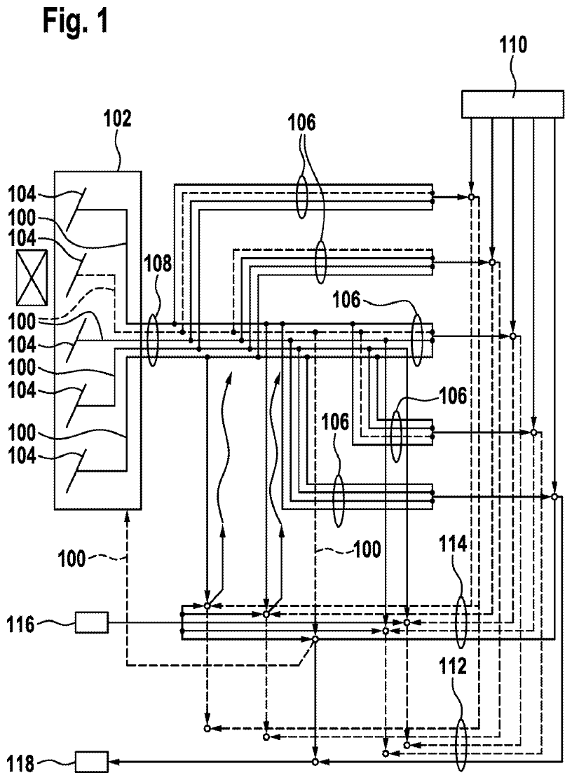

FIG. 1 shows a representation of a sequence of a method according to an exemplary embodiment for detecting erroneous antenna signals 100 from a radar sensor 102 having a plurality of antennas 104. In this case, a subset 106 of the antenna signals 100 is formed from a complete set 108 of the antenna signals 100 by omitting at least one antenna signal 100 of the complete set 108.

Using the subset 106 and an antenna pattern 110 of the radar sensor 102, a direction 112 to an object represented in the antenna signals 100 is estimated and, in so doing, a correlation value 114 of the subset 106 of the antenna signals 100 with the antenna pattern 110 in the estimated direction 112 is determined.

The correlation value 114 is compared to a selection condition 116. If the correlation value 114 satisfies the selection condition 116, the antenna signal 100 that was omitted when the subset 106 was formed is classified as the erroneous antenna signal 100.

The estimated direction 112 can be selected as the angle 118 to the object if the correlation value 114 satisfies the selection condition 116.

In an exemplary embodiment, at least one further subset 106 is formed if the correlation value 114 does not satisfy the selection condition 116. For the further subset 106, at least one other antenna signal 100 of the complete set 108 is omitted.

Using the further subset 106, a further direction 112 to the object is then estimated and, in so doing, a further correlation value 114 of the further subset 106 of the antenna signals 100 with the antenna pattern 110 in the further estimated direction 112 is determined.

The further correlation value 114 is compared to the selection condition 116 and the antenna signal 100 that was omitted when the further subset 106 was formed is classified as the erroneous antenna signal 100 if the further correlation value 114 satisfies the selection condition 116.

In an exemplary embodiment, this sequence is repeated until a subset 106 of the antenna signals 100 whose correlation value 114 satisfies the selection condition 116 is found. Several antenna signals 100 of the complete set 108 may also be omitted in this case.

In an exemplary embodiment, the correlation values 114 of several different subsets 106 are compared to one another. In this case, the selection condition 116 is the maximally achieved correlation value 114. The at least one antenna signal 100 omitted from the subset 106 with the greatest correlation value 114 is classified as the erroneous antenna signal 100.

In this case, the direction 112 estimated using the subset 106 with the greatest correlation value 114 can be selected as the angle 118 to the object.

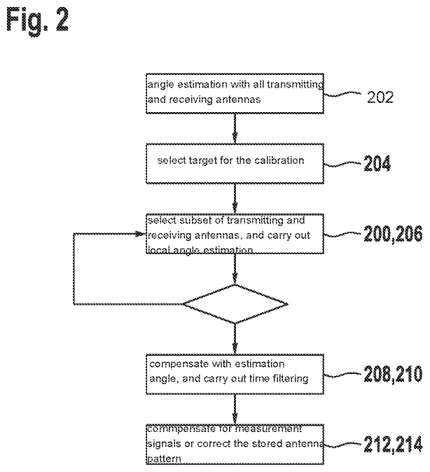

FIG. 2 shows a further representation of a sequence of a method according to an exemplary embodiment. The method essentially corresponds to the method in FIG. 1.

In addition, an angle estimation 202 with all transmitting and receiving antennas of the radar sensor takes place prior to the selection 200 of the subset. Subsequently, a selection 204 of at least one suitable target for the calibration takes place. The target in this case corresponds to the object in FIG. 1.

Then, the selection 200 of the subset of the transmitting and receiving antennas takes place, and the local angle estimation 206 is carried out.

If the maximally achieved correlation is sufficiently high, a compensation 208 with new estimated angle values and a time-filtering 210 of the compensation values are carried out.

If the maximally achieved correlation is not sufficiently high, the selection 200 and the angle estimation 206 are carried out again.

The compensation values are used to compensate 212 for the measurement signals or to correct 214 the stored antenna pattern.

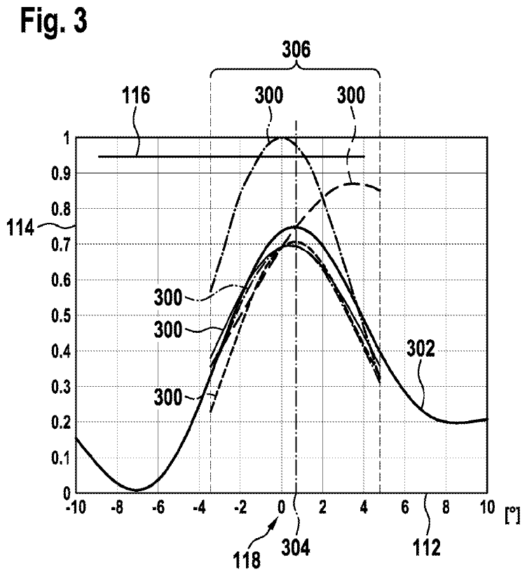

FIG. 3 shows a representation of direction estimations 300 for an object. The direction estimations 300 may, for example, be the estimations of FIG. 1 and are based on the different subsets of the antenna signals. Thus, for each direction estimation 300, at least one of the antenna signals of the complete set has been omitted.

The direction estimations 300 are shown in a graph that plots the direction 112 in degrees on its abscissa and the correlation value 114 on its ordinates. The direction 112 is shown here as a positive and negative deviation from an absolute angle 118 to the object. The correlation value 114 is normalized to a value range of zero to one.

The direction estimations 300 are shown as profiles of the correlation value 114 over the direction 112. Each direction estimation 300 has a maximum of the correlation value 114 with the antenna pattern. The maximum indicates the direction 112 estimated using the respective subset of the antenna signals. The maximally achieved correlation values 114 are different. The more accurately the respective direction estimation 300 matches the antenna pattern, the greater is its correlation value 114.

The direction estimation 300 with the highest achieved correlation value 114 correlates best with the antenna pattern. The subset of antenna signals used for this direction estimation 300 is assumed to be the subset with the least phase/amplitude errors. Thus, the at least one antenna signal omitted from this subset is highly likely erroneous and can be marked as erroneous.

If the antenna signals included in this subset are slightly erroneous, a slightly reduced correlation value 114 results in comparison to a maximally achievable correlation value 114 of one. If the thus achieved correlation value 114 satisfies a selection criterion 116, the omitted antenna signal can still be detected as erroneous.

Here, the maximal correlation value 114 of the best direction estimation 300 is one. The antenna signals used for this direction estimation 300 thus have the least phase/amplitude error. In all other direction estimations 300, the subsets used each include the at least one erroneous antenna signal, as a result of which only a significantly reduced correlation value 114 is achieved.

In an exemplary embodiment, a rough estimation 302 with the complete set of the antenna signals is additionally represented in the graph. A profile of the correlation value 114 over the direction 112 for the rough estimation 302 is also represented. The rough estimation 302 has a significantly reduced maximal correlation value 114 with the antenna pattern due to the additional use of the at least one erroneous antenna signal. The maximum of the rough estimation 302 indicates an estimated rough direction 304 to the object.

On the basis of the rough direction 304, a direction range 306 of plus/minus two degrees is defined in the antenna pattern here. The direction estimations 300 on the basis of the subsets of the antenna signals are limited to this direction range 306. The direction estimation 300 with the highest correlation value 114 is thus sought only within this direction range 306. As a result, resource consumption by the direction estimations 300 and by the comparison of the correlation values 114 can be reduced.

In an exemplary embodiment, the direction 112 to the object defined by the maximum of the correlation value 114 is defined as the angle 118 to the object.

In other words, an online calibration of the antenna pattern by partial array evaluation is presented.

For this purpose, an angle estimation with all transmitting and receiving antennas is carried out first. Suitable targets are selected on the basis of various criteria. A criterion may inter alia be that the SNR (signal-to-noise ratio) is high enough. A further criterion may be a single-target case or that a deviation from the single-target signal model is small enough. Likewise, isolated targets, in the case of which no strong other targets are present in similar distance/velocity cells, may be used as a criterion.

In the angle estimation, the once-measured antenna pattern is correlated with the receive signals x for one or more transmitting and/or receiving antennas. The antenna pattern is in this case represented in the form of angle-dependent, normalized vectors

$$a ( θ ) .$$

The receive signals for a target are also combined into a normalized vector

$$x .$$

In this case, the function

$${q}^{2} ( θ )$$

is mathematically maximized in order to estimate the target angle. The result \hat{θ} of the search for the maximum is the estimated target angle.

$$\frac{\vert {q}^{2} ( θ ) = \vert {\underline{a}}^{H} ( θ ) \cdot \underline{x} {\vert}^{2}}{\vert \hat{θ} = arg max {q}^{2} ( θ ) \vert}$$

Due to the amplitude and phase deviations, the estimated angles of the selected targets will not match the actual angles. This deviation (bias) can be avoided or at least reduced if only the transmitting and receiving antennas whose relative phase is not or only slightly disrupted are used for the angle determination.

In a second step, several angle estimations are thus carried out with different subsets of the transmitting and receiving antennas. In so doing, only a local search around the angle already ascertained in the first step takes place. As a result, ambiguities due to the reduced number of channels in the second step can be avoided. Of the several angle estimations, an angle estimation for which a correlation value as high as possible is achieved for the selected targets and at the same time the number of channels used is not too low is selected. In particular, at least three channels are needed so that any still present amplitude and/or phase deviations can be detected on the basis of a degradation of the correlation value and do not lead only to an angle error (with a high correlation value at the same time).

This method achieves a selection of the angle estimation in which the channels used are disturbed as little as possible.

With the thus improved angle estimation, the compensation for the degradation of the correlation value is then carried out. A complete calibration, i.e., both a compensation for the angle error and a compensation for the correlation degradation, can thereby be achieved.

The compensation coefficients determined in this manner can be used either to compensate for the measurement signals or to correct the stored antenna pattern. If the compensation coefficients are determined in an angle-dependent manner, it is advantageous to correct the antenna pattern.

By way of example, the approach presented here is described for an antenna array with the positions [0; 0.5; 2; 3; 5] lambda (lambda: wavelength) and a target at 0°. In FIG. 3, the antenna at the position 5 lambda, by way of example, has a phase error of 80°, i.e., the vector of the phase error is angle-independent [0° 0° 0° 0° 80°]. In the estimation with all antenna elements, an angle error and a degradation of the correlation occur.

If the calibration coefficients were determined with the angle estimated with all antenna elements, [0°-7°−27°-41° 11°] would result. This deviation from the actual phase error is due to the comparison with the antenna pattern at the erroneous angular position.

If the compensation were to be carried out with these coefficients, the degradation of the correlation value would be compensated, but not the angle error.

In contrast, in the approach presented here, a local angle estimation (dashed curves, here +/−1.5° around the maximum found with all antenna elements) is carried out with different subsets of the antennas in each case. The estimation with the highest correlation maximum provides the correct angle at 0° and is based on the undisturbed antenna subset. Thus, the correct amplitude and phase error can then be determined by comparing the measurement signal of all antennas to the stored antenna pattern at the thus estimated angular position.

This principle can also be applied if more than one antenna is affected by amplitude and/or phase errors. Only at least three undisturbed or only slightly disturbed channels are required for the local estimations.

The method can also be applied to MIMO arrays having a plurality of transmitting and receiving antennas. It is advantageous here to consider omitting channels not in the virtual array but in the transmit and receive array. This significantly reduces the number of configurations, or subsets of virtual arrays, to be investigated.

The best subset of transmitting and receiving antennas can be ascertained either via any possible subsets with more than three virtual channels or sequentially by successively reducing the number of channels.

Lastly, it should be noted that terms such as “comprising,” “including,” etc. do not exclude other elements or steps, and terms such as “one” or “a” do not exclude a plurality. Reference signs should not be construed as limitations.

1-13. (canceled)

14. A method for detecting erroneous antenna signals from a radar sensor having a plurality of antennas, the method comprising the following steps:
forming a subset of antenna signals by omitting at least one antenna signal from a complete set of the antenna signals;
estimating a direction to an object using the subset and an antenna pattern of the radar sensor;
determining a correlation value of the subset of the antenna signals with the antenna pattern in the estimated direction; and
classifying the at least one omitted antenna signal of the subset as erroneous when the correlation value satisfies a selection condition.

15. The method according to claim 14, wherein a further subset is formed from the complete set by omitting at least one other antenna signal from the complete set when the correlation value does not satisfy the selection condition, wherein a further direction to the object is estimated using the further subset and the antenna pattern, and a further correlation value of the further subset of the antenna signals with the antenna pattern in the estimated further direction is determined, and wherein the at least one omitted other antenna signal for the further subset is classified as erroneous when the further correlation value satisfies the selection condition.

16. The method according to claim 15, wherein the correlation value and the further correlation value are compared to one another when none of the correlation value and the further correlation value satisfies the selection condition, wherein the at least one omitted antenna signal for the subset or the at least one other omitted antenna signal for the further subset with a greatest correlation value is classified as erroneous.

17. The method according to claim 14, wherein a rough direction to the object is ascertained using all antenna signals and the antenna pattern, wherein the estimation of the direction using the subset is limited to a direction range around the rough direction.

18. The method according to claim 14, wherein the subset includes at least three antenna signals.

19. The method according to claim 14, wherein a rough direction to the object is read in and the estimation of the direction using the subset is limited to a direction range around the rough direction, wherein the subset includes at least two of the antenna signals.

20. The method according to claim 14, in which the object is selected using all of the antenna signals and at least one object criterion from a group of objects represented in the antenna signals.

21. The method according to claim 14, wherein a compensation value for the at least one antenna signal classified as erroneous is calculated using the estimated direction, wherein the at least one antenna signal classified as erroneous and/or the antenna pattern is compensated using the compensation value.

22. The method according to claim 14, wherein the at least one erroneous antenna signal is determined via at least two measurements of the object.

23. The method according to claim 14, wherein one compensation value is calculated per measurement, wherein the compensation values of the measurements are time-filtered to obtain a filtered compensation value, wherein the at least one antenna signal classified as erroneous and/or the antenna pattern is compensated using the filtered compensation value.

24. A control device configured to detect erroneous antenna signals from a radar sensor having a plurality of antennas, the control device configured to:
form a subset of antenna signals by omitting at least one antenna signal from a complete set of the antenna signals;
estimate a direction to an object using the subset and an antenna pattern of the radar sensor;
determine a correlation value of the subset of the antenna signals with the antenna pattern in the estimated direction; and
classify the at least one omitted antenna signal of the subset as erroneous when the correlation value satisfies a selection condition.

25. A non-transitory machine-readable storage medium on which is stored a computer program for detecting erroneous antenna signals from a radar sensor having a plurality of antennas, the computer program, when executed by a computer, causing the computer to perform the following steps:
forming a subset of antenna signals by omitting at least one antenna signal from a complete set of the antenna signals;
estimating a direction to an object using the subset and an antenna pattern of the radar sensor;
determining a correlation value of the subset of the antenna signals with the antenna pattern in the estimated direction; and
classifying the at least one omitted antenna signal of the subset as erroneous when the correlation value satisfies a selection condition.
